(19) United States
(12) Patent Application Publication
(10) Pub. No.: US 2015/0326524 A1
(43) Pub. Date: Nov. 12, 2015

(54) ADDRESS RESOLUTION IN SOFTWARE-DEFINED NETWORKS

(71) Applicants: Krishna Mouli TANKALA, Bangalore, Karnataka (IN); Santosh Kumar SINGH, Bangalore, Karnataka (IN); HEWLETT-PACKARD DEVELOPMENT COMPANY, L.P., Houston, TX (US)

(72) Inventors: Krishna Mouli TANKALA, Bangalore, Karnataka (IN); Santosh Kumar SINGH, Bangalore, Karnataka (IN)

(21) Appl. No.: 14/763,107

(22) PCT Filed: Jan. 24, 2013
(86) PCT No.: PCT/IN2013/000051

§ 371 Date: Jul. 23, 2015

(51) Int. Cl. H04L 29/12; G06F 9/455

(52) U.S. Cl. CPC H04L 61/103; G06F 9/45558; H04L 61/6022; G06F 2009/45595

(57) ABSTRACT

Provided is a method of address resolution in a software-defined network. An Address Resolution Protocol (ARP) request message is received on a network device. The Address Resolution Protocol (ARP) request message from the network device is forwarded to an OpenFlow controller. A determination is made whether the OpenFlow controller includes information to identify a Media Access Control (MAC) address corresponding to an IP address of a receiving device from the Address Resolution Protocol (ARP) request message. A response is generated depending on whether the OpenFlow controller includes said information.

### BACKGROUND

An Internet Protocol (IP) address is a logical address assigned to each device in a computer network that uses the Internet Protocol for communication. In order to locate a device in the network, the logical IP address is converted to a physical machine address (also known as a Media Access Control or MAC address). This process is called “address resolution”. The function of address resolution in Internet Protocol version 4 (IPv4) and Internet Protocol version 6 (IPv6) is handled by Address Resolution Protocol (ARP) and Neighbor Discovery Protocol (NDP) respectively.

### BRIEF DESCRIPTION FO THE DRAWINGS

For a better understanding of the solution, embodiments will now be described, purely by way of example, with reference to the accompanying drawings, in which:

FIG. 1 is a schematic block diagram of a network system based on Software-defined Networking (SDN) architecture, according to an example.

FIG. 2 is a schematic block diagram of an OpenFlow controller system of FIG. 1, according to an example.

FIG. 3 shows a flow chart of a method, according to an example.

FIG. 4 is a schematic block diagram of an OpenFlow controller system hosted on a computer system, according to an example.

### DETAILED DESCRIPTION OF THE INVENTION

Depending on Internet Protocol (IP) version, Address Resolution Protocol (ARP) or Neighbor Discovery Protocol (NDP) is used to map an IP network address to a hardware address. For instance, in the case of ARP, the process may work as follows. When an incoming packet meant for a host machine on a local area network (LAN) arrives at a gateway, the gateway asks the ARP to find a physical host (or MAC address) that matches the IP address. The ARP first checks the ARP cache and if the address is found, the packet is forwarded to the right host machine. If no entry is found for the IP address in the ARP cache, ARP broadcasts a request packet to all the machines on the LAN. On receiving a response from a machine that recognizes the IP address as its own, ARP sends the packet to the machine.

With the advent of cloud computing, the use of virtual machines in a network is increasing. For example, in a datacenter environment a large number of virtual machines are getting deployed. A consequence of this increased use of virtual machines in a network environment is that a lot of packet exchange may take place between network nodes for address resolution. This in turn could lead to network overload.

Proposed is a solution for address resolution in a computer network which is based on Software-defined Networking (SDN) architecture (in other words, “Software-defined Networks”). Proposed solution uses an OpenFlow controller for address resolution in a SDN-based network.

In Software-defined Networking (SDN) architecture the control plane is implemented in software separate from the network equipment and the data plane is implemented in the network equipment. OpenFlow is a leading protocol for SDN architecture. In OpenFlow network, data forwarding on a network device is controlled through flow table entries populated by an OpenFlow controller that manages the control plane for that network. A network device that receives packets on its interfaces looks up its flow table to check the actions that need to be taken on a received frame. By default an OpenFlow enabled network device creates a default flow table entry to send all packets that do not match any specific flow entry in the table to the OpenFlow Controller. In this manner, the OpenFlow controller becomes aware of all new network traffic coming in on a device and programs a flow table entry corresponding to a new traffic pattern on the receiver network device for subsequent packet forwarding of that flow.

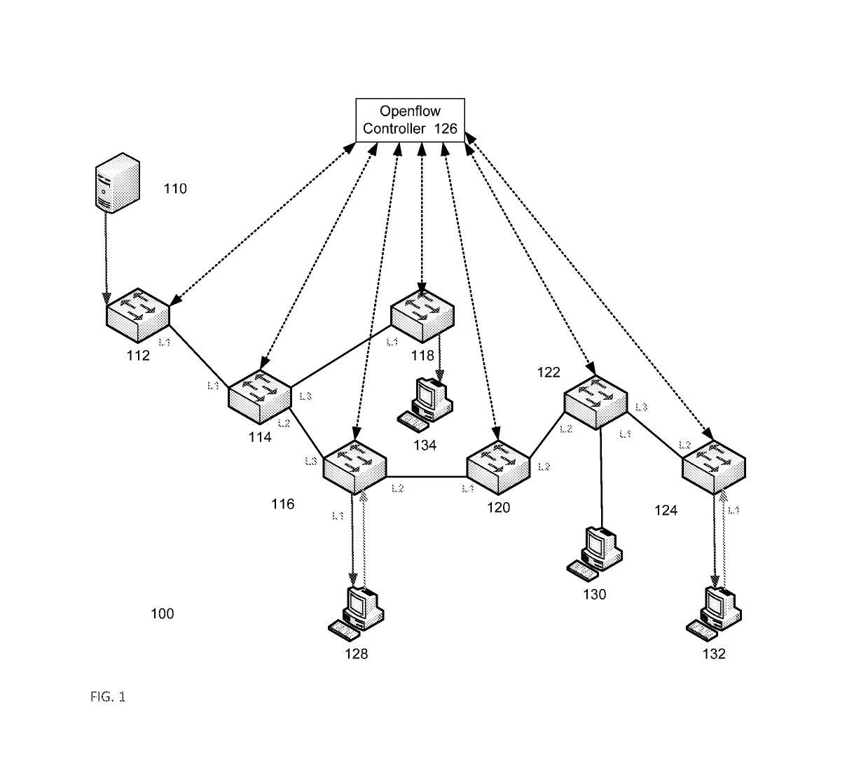

FIG. 1 is a schematic block diagram of a network system based on Software-defined Networking (SDN) architecture, according to an example.

Network system 100 includes a source system 110, network devices 112, 114, 116, 118, 120, 122, 124, OpenFlow controller 126 and host computer systems 128, 130, 132.

OpenFlow controller system 126 is connected to network devices 112, 114, 116, 118, 120, 122, 124, source system 110 and host computer systems 128, 130, 132 through a network, which may be wired or wireless. The network may be a public network, such as, the Internet, or a private network, such as, an intranet. The number of network devices 112, 114, 116, 118, 120, 122, 124 illustrated in FIG. 1 is by way of example, and not limitation. The number of network devices deployed in a network system 100 may vary in other implementations. Similarly, there may be additional source systems, OpenFlow controllers and host computer systems in other implementations.

Source system 110 is a computing system (for example, a computer server, a desktop computer, and the like) that may be a source of data packets in network system 100. For example, in an implementation, source system 100 may host multicast content. Multicast content may include data, image, audio, video, multimedia, and other like content. Multicast content present on source system 100 may be shared with host computer systems 128, 130, 132 through network devices 112, 114, 116, 118, 120, 122, 124.

Network devices 112, 114, 116, 118, 120, 122, 124 may be, but not limited to, a network switch, virtual switch, or router (for example, an edge router, a subscriber edge router, an Inter-provider Border Router or a core router). In an implementation, network devices 112, 114, 116, 118, 120, 122, 124 are Open-Flow enabled devices. Network devices 112, 114, 116, 118, 120, 122, 124 transfer source data from a source system to end user systems or devices.

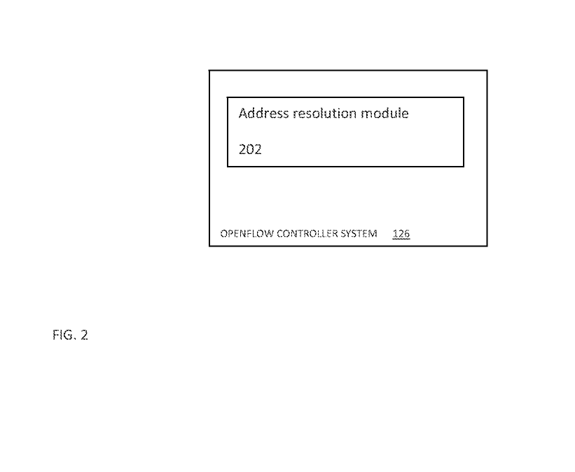

OpenFlow controller system 126 is software (machine executable instructions) which controls OpenFlow logical switches via the OpenFlow protocol. More information regarding the OpenFlow controller can be obtained, for instance, from web links http://www.openflow.org/documents/openflow-spec-v1.0.0.pdf and https://www.opennetworking.org/images/stories/downloads/of-config/of-config-1.1.pdf. OpenFlow is an open standard communications protocol that gives access to the forwarding plane of a network switch or router over a network. It provides an open protocol to program a flow table in a network device (such as, a router) thereby controlling the way data packets are routed in a network. Through OpenFlow, the data and control logic of a network device are separated, and the control logic is moved to an external controller such as OpenFlow controller system 126. The OpenFlow controller system 126 maintains all of network rules and distributes the appropriate instructions to network devices 112, 114, 116, 118, 120, 122, 124. It essentially centralizes the network intelligence, while the network maintains a distributed forwarding plane through OpenFlow-enabled network devices. Components of OpenFlow controller system 126 are illustrated in FIG. 2 and described below.

Host computer system 128, 130, 132 may be a desktop computer, notebook computer, tablet computer, computer server, mobile phone, personal digital assistant (PDA), and the like. In an example, host computer system 128, 130, 132 may include a client or multicast application for receiving multicast data from a source system 110 hosting multicast content.

FIG. 2 is a schematic block diagram of an OpenFlow controller system of FIG. 1, according to an example.

OpenFlow controller system 126 may include and/or support standard OpenFlow controller components. In an implementation, OpenFlow controller system 126 includes address resolution module 202. In an example, address resolution module 202 receives an Address Resolution Protocol (ARP) request message on a network device, forwards the Address Resolution Protocol (ARP) request message from the network device to an OpenFlow controller, determines whether the OpenFlow controller includes information to identify a Media Access Control (MAC) address corresponding to an IP address of a host device in the network from the Address Resolution Protocol (ARP) request message, and generates a response depending on whether the OpenFlow controller includes said information.

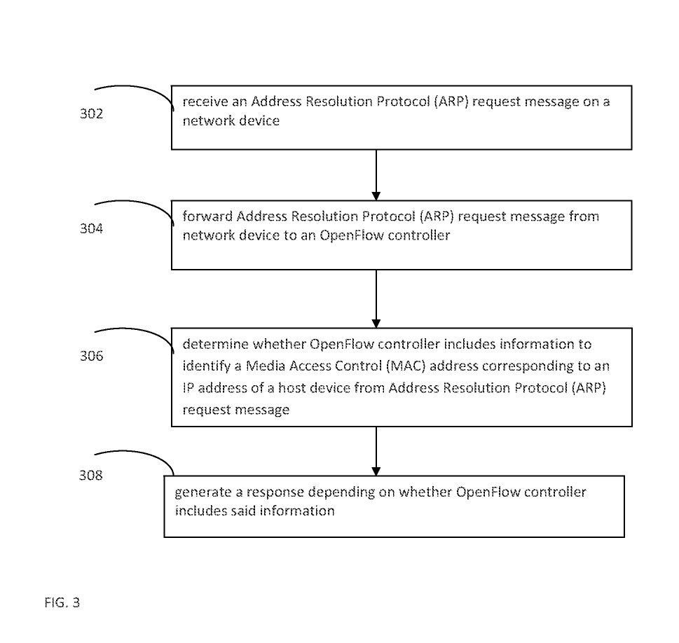

FIG. 3 shows a flow chart of a method of address resolution in a software-defined network. In an implementation, the software-defined network makes use of the OpenFlow protocol. Details related to the OpenFlow protocol can be obtained from the web link https://www.opennetworking.org/standards/intro-to-openflow. During description references are made to FIG. 1 to illustrate the address resolution mechanism. As mentioned earlier, FIG. 1 depicts a software-defined network, which in an implementation may be based on OpenFlow protocol. Thus, in other words, the proposed solution could be implemented in an OpenFlow based network which may include, with reference to FIG. 1, a source system 110, network devices 112, 114, 116, 118, 120, 122, 124, OpenFlow controller system 126 and host computer systems 128, 130, 132.

At block 302, an Address Resolution Protocol (ARP) request message is received on a network device of an OpenFlow based network (or SDN network). The request message may be received from a host device (or requesting device) present on the OpenFlow based network. To provide an illustration with reference to FIG. 1, let's assume that host computer system (or requesting device) 128 sends an ARP request message for host computer system (or receiving device) 134 to network device 116 (for example, a switch). An ARP request message includes, among other details, IP addresses of the requesting device 128 and the receiving device 134. The purpose behind sending an ARP request message is to obtain the physical machine address (Media Access Control (MAC) address) of a device on a network. In the present illustration, host computer system (or requesting device) 128 sends an ARP request message to determine the MAC address of host computer system (or receiving device) 134. Since host computer system (or requesting device) 128 is connected to network device 116, the ARP message is first received at an interface of network device 116.

At block 304, the Address Resolution Protocol (ARP) request message received by network device 116 is forwarded to an OpenFlow controller (for example, OpenFlow controller system 126 of FIG. 1). In an OpenFlow based network (such as network 100 of FIG. 1), data plane forwarding on a network device (such as network device 116) is controlled through flow table entries on the network device and flow entries are pushed by an OpenFlow controller that manages the data plane for that network. Typically, once a network device receives a data packet on its interface, it looks up the flow table to check what action is to be taken on the received frame. In case of an OpenFlow based network, if a network device is unable to find an associated flow entry, it sends the data packet to the OpenFlow controller. In other words, if there's no rule on the network device matching a flow entry to a destination MAC address, the ARP request message is forwarded to the OpenFlow controller. Referring to the present illustration with reference to 1, network device forwards the ARP message to OpenFlow controller system 126.

At block 306, a determination is made whether the OpenFlow controller includes information to identify a Media Access Control (MAC) address corresponding to an IP address of a receiving device (a host device in the network) from the Address Resolution Protocol (ARP) request message. Once an OpenFlow controller receives an ARP message, it checks its records (for instance present in a repository such as a table) to determine whether there's an associated MAC address entry corresponding to the IP address of the receiving device present in the ARP message. In the context of the present illustration with reference to 1, network device 116 would check its repository to determine whether a MAC address corresponding to the IP address of the host computer system 134 (the receiving device) is present in its records.

At block 308, an appropriate response is generated by the OpenFlow controller depending on whether it includes information to identify a Media Access Control (MAC) address corresponding to an IP address of a receiving device from the Address Resolution Protocol (ARP) request message. If the OpenFlow controller identifies the associated MAC address, it creates an ARP response message and sends it to the requesting host computer system. The ARP response message would contain the MAC address of the receiving host computer system. In the context of FIG. 1, in case OpenFlow controller system 126 includes a MAC address corresponding to the IP address of the receiving device 134, it creates an ARP message containing said MAC address and sends it to the requesting device 128.

On the other hand if the OpenFlow controller does not have information to identify a Media Access Control (MAC) address corresponding to an IP address of a receiving device, it may broadcast the request message to all devices present on the network or it may drop the request data packet depending on the current mode of operation of the OpenFlow controller. In the event the request message is broadcasted, the OpenFlow controller waits for a host device that recognizes the IP address (in the ARP request message) as its own to respond with a message so indicating. Said differently, once a host device in the network recognizes the IP address as its own it returns a reply indicating its recognition to the OpenFlow controller. In the context of FIG. 1, once host computer system 134 recognizes the IP address in the broadcast as its own, it sends a response message containing its MAC address to the OpenFlow controller 126. Upon receipt of such response from a host device 124, the OpenFlow controller associates the IP address with the MAC address of the host device 134. OpenFlow controller also updates its repository for future reference and sends the packet to the MAC address of the host device (receiving device 134) that replied. In like manner, the OpenFlow controller builds all logical IP address to MAC address associations for each host device in the network and maintains these associations in its repository.

In future, if the OpenFlow controller receives an ARP request message from another host device for a host device whose IP address to MAC address association has already been recorded in the above described manner, the OpenFlow controller checks for such association and if it finds the association information in its records provides the same to the requesting host device. For example in case of FIG. 1, once the OpenFlow controller system 126 builds the IP address to MAC address association information for host computer system 134, in future if a host computer, such host computer system 130, sends an ARP request for host computer system 134, the OpenFlow controller can provide the same after checking its records.

If the controller is operating in secure mode, it would return the MAC address only if the MAC address is present (for a given IP address in the request message) in the repository, otherwise it drops the packet. Secure mode operation could be achieved by having statically push IP address to MAC address associations or building IP address to MAC address associations based on the Dynamic Host Configuration Protocol (DHCP) packet exchanges. In a non-secure mode, OpenFlow controller may forward the packet and update its repository.

Proposed address resolution solution provides an efficient mechanism to avoid network flooding from ARP request messages. The mechanism therefore saves precious network bandwidth and overloading on a network.

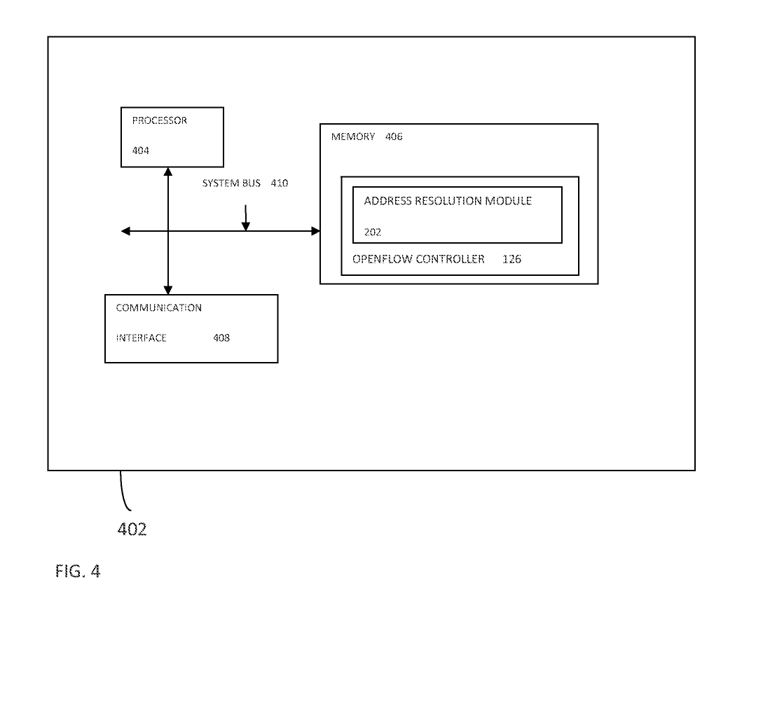

FIG. 4 is a schematic block diagram of an OpenFlow controller system hosted on a computer system, according to an example.

Computer system 402 may include processor 404, memory 406, OpenFlow controller system 126 and a communication interface 408. OpenFlow controller system 126 includes address resolution module 202. The components of the computing system 402 may be coupled together through a system bus 410.

Processor 404 may include any type of processor, microprocessor, or processing logic that interprets and executes instructions.

Memory 406 may include a random access memory (RAM) or another type of dynamic storage device that may store information and instructions non-transitorily for execution by processor 404. For example, memory 406 can be SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc. Memory 406 may include instructions that when executed by processor 404 implement OpenFlow controller system 126.

Communication interface 408 may include any transceiver-like mechanism that enables computing device 402 to communicate with other devices and/or systems via a communication link. Communication interface 408 may be a software program, a hard ware, a firmware, or any combination thereof. Communication interface 408 may use a variety of communication technologies to enable communication between computer system 402 and another computer system or device. To provide a few non-limiting examples, communication interface 408 may be an Ethernet card, a modem, an integrated services digital network (“ISDN”) card, etc.

OpenFlow controller system 126 may be implemented in the form of a computer program product including computer-executable instructions, such as program code, which may be run on any suitable computing environment in conjunction with a suitable operating system, such as Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

In an implementation, OpenFlow controller system 126 may be read into memory 406 from another computer-readable medium, such as data storage device, or from another device via communication interface 408.

For the sake of clarity, the term “module”, as used in this document, may mean to include a software component, a hardware component or a combination thereof. A module may include, by way of example, components, such as software components, processes, tasks, co-routines, functions, attributes, procedures, drivers, firmware, data, databases, data structures, Application Specific Integrated Circuits (ASIC) and other computing devices. The module may reside on a volatile or non-volatile storage medium and configured to interact with a processor of a computer system.

It would be appreciated that the system components depicted in FIG. 4 are for the purpose of illustration only and the actual components may vary depending on the computing system and architecture deployed for implementation of the present solution. The various components described above may be hosted on a single computing system or multiple computer systems, including servers, connected together through suitable means.

It should be noted that the above-described embodiment of the present solution is for the purpose of illustration only. Although the solution has been described in conjunction with a specific embodiment thereof, numerous modifications are possible without materially departing from the teachings and advantages of the subject matter described herein. Other substitutions, modifications and changes may be made without departing from the spirit of the present solution.

We claim:

1. A method of address resolution in a software-defined network, comprising:
receiving an Address Resolution Protocol (ARP) request message on a network device;
forwarding the Address Resolution Protocol (ARP) request message from the network device to an OpenFlow controller;
determining whether the OpenFlow controller includes information to identify a Media Access Control (MAC) address corresponding to an IP address of a host device in the network from the Address Resolution Protocol (ARP) request message; and
generating a response depending on whether the OpenFlow controller includes said information.

2. The method of claim 1, wherein the network device is an OpenFlow-enabled device.

3. The method of claim 1, wherein the response comprises providing the Media Access Control (MAC) address corresponding to the IP address of the host device to a requesting device if the OpenFlow controller includes said information.

4. The method of claim 1, wherein the response comprises broadcasting the Address Resolution Protocol (ARP) request message to all network devices present in the network if the OpenFlow controller does not include said information to identify the host device.

5. The method of claim 1, further comprising determining the MAC address corresponding to the IP address of the host device from a response message received from the host device.

6. The method of claim 5, further comprising creating a record of the MAC address corresponding to the IP address of the host device in the OpenFlow controller.

7. A system for address resolution in a software-defined network, comprising:
a network device to receive an Address Resolution Protocol (ARP) request message;
a computer comprising:
an OpenFlow controller to receive the Address Resolution Protocol (ARP) request message from the network device, wherein the OpenFlow controller includes an address resolution module to:
determine whether the OpenFlow controller includes information to identify a Media Access Control (MAC) address corresponding to an IP address of a host device in the network from the Address Resolution Protocol (ARP) request message; and
generate a response depending on whether the OpenFlow controller includes said information.

8. The system of claim 7, wherein the network device is a gateway device.

9. The system of claim 7, wherein the network device is a network switch or router.

10. The system of claim 7, wherein the host device is a computer system or a virtual machine.

11. The system of claim 7, wherein the OpenFlow controller includes a repository to store the Media Access Control (MAC) address corresponding to the IP address of a host device in the network.

12. A computer system for address resolution in a software-defined network, comprising:
an OpenFlow controller to receive the Address Resolution Protocol (ARP) request message from a network device, wherein the OpenFlow controller includes an address resolution module to:
determine whether the OpenFlow controller includes information to identify a Media Access Control (MAC) address corresponding to an IP address of a host device in the network from the Address Resolution Protocol (ARP) request message; and
generate a response depending on whether the OpenFlow controller includes said information.

13. The system of claim 12, wherein the address resolution request message originates from a computer system or a virtual machine.

14. The system of claim 12, wherein the response comprises providing the Media Access Control (MAC) address corresponding to the IP address of the host device to a requesting device if the OpenFlow controller includes said information or broadcasting the Address Resolution Protocol (ARP) request message to all network devices present in the network if the OpenFlow controller does not include said information to identify the host device.

15. A non-transitory processor readable medium, the non-transitory processor readable medium comprising machine executable instructions, the machine executable instructions when executed by a processor causes the processor to:
receive an Address Resolution Protocol (ARP) request message on a network device;
forward the Address Resolution Protocol (ARP) request message from the network device to an Open Flow controller;
determine whether the OpenFlow controller includes information to identify a Media Access Control (MAC) address corresponding to an IP address of a host device in the network from the Address Resolution Protocol (ARP) request message; and
generate a response depending on whether the OpenFlow controller includes said information.
